(19) United States
(12) Patent Application Publication
(10) Pub. No.: US 2019/0234306 A1
(43) Pub. Date: Aug. 1, 2019

(54) Silencer and Compressor

(71) Applicant: MAN Energy Solutions SE, Augsburg (DE)

(72) Inventors: Urban Spatz, Neusass (DE); Stefan Mayr, Horgau (DE)

(21) Appl. No.: 16/264,219

(22) Filed: Jan. 31, 2019

(30) Foreign Application Priority Data
Feb. 1, 2018 (DE) 10 2018 102 237.9

(51) Int. Cl. F02C 7/045; F02B 77/10; F01D 25/24

(52) U.S. Cl. CPC F02C 7/045; F02B 77/10; F05D 2260/96; F05D 2220/40; F01D 25/24

(57) ABSTRACT

A silencer of a compressor for aspirating air to be compressed, with a housing having a front plate and a rear plate, a circumferential surface extending between the front plate and rear plate and bordering a suction area, via which the air can be aspirated, and a recess in the rear plate, via which the aspirated air can be supplied to the compressor. A flow-carrying metal component, in particular a wire component, is arranged in or adjacent to the suction area as a flame absorber.

### BACKGROUND OF THE INVENTION

### 1. Field of the Invention

The invention relates to a silencer of a compressor, and to a compressor in particular of a turbocharger with a silencer.

### 2. Description of the Related Art

FIG. 1 shows the basic structural design of a turbocharger 1.

The turbocharger 1 has a turbine 2 for depressurizing exhaust gas of an internal combustion engine. A turbocharger 1 further has a compressor 3 for compressing air or charge air, specifically using the energy produced in the turbine while depressurizing the exhaust gas.

The turbine 2 has a turbine housing 4 and a turbine rotor 5. The compressor 3 has a compressor housing 6 and a compressor rotor 7. The compressor rotor 7 is coupled with the turbine rotor 5 by a shaft 8, which is mounted in a bearing housing 9. The bearing housing 9 is positioned between the turbine housing 4 and compressor housing 5, and is connected with both the turbine housing 4 and compressor housing 5. FIG. 1 further shows a compressor-side silencer 10 for aspirating the air to be compressed in the compressor 3.

The turbine housing 4 of the turbine 2 has an inflow housing 11 and an outflow housing 12. The exhaust gas to be depressurized in the area of the turbine 2 can be supplied to the turbine rotor 5 via the inflow housing 11. Gas depressurized in the area of the turbine rotor 5 flows away from the turbine 2 via the outflow housing 12.

In addition to the inflow housing 11 and outflow housing 12, the turbine housing 4 has an insert 13 that runs, in particular, in the area of the inflow housing 11, specifically adjacent to the turbine rotor 5, radially outwardly bordering rotor blades 14 of the turbine rotor 5. The turbine housing 4 further has a nozzle ring 15. The nozzle ring 15 is also referred to as a turbine guide apparatus.

The silencer 10 serves to aspirate the air to be compressed by the compressor, and has a housing 16 with a front plate 17 and rear plate 18. Extending between the front plate 17 and rear plate 18 is a circumferential surface 19 of the silencer 10 that borders a suction area of the silencer 10 and is defined at least in sections by a filter fleece 20. Air to be compressed in the compressor 3 is aspirated via the filter fleece 20, i.e., via the circumferential surface 19 of the silencer 10. The aspirated air to be compressed can be supplied to the compressor 3 via a recess 21 introduced into the rear plate 18.

Known from DE 100 02 581 C2 is a turbocharger with a silencer.

In the event of damage, flame formation might possibly arise inside of the compressor. Flames can then exit into the environment via the silencer.

Known from DE 199 46 213 C2 is an explosion-relief valve with integrated flame absorber. The flame absorber is comprised of metal strips layered one on top of the other, which are provided on a portion of their width with irregular waves. Such an explosion-relief valve is used in crankcases of internal combustion engines.

### SUMMARY OF THE INVENTION

Proceeding from the above, an object of one aspect of the invention is to provide a novel silencer and novel compressor, in particular of a turbocharger.

In a first aspect, a metal component that can carry a flow, in particular a wire component, is arranged in or adjacent to the suction area of the silencer as a flame absorber. The surface structure of the metal component, in particular the wire component, makes it suitable for lowering the temperature of the fluid flow, and thereby prevent flames from exiting. In a second aspect, an explosion-relief valve with integrated flame absorber is integrated into the front plate. The present invention proposes a silencer with flame absorber. In a first aspect, the flame absorber involves a flow-conducting metal component, which is positioned in the suction area or adjacent to the suction area, in particular underneath a filter fleece. In the second aspect, which can also be applied in combination with the first aspect, the flame absorber is part of an explosion-relief valve integrated into the front plate of the housing of the silencer. In the event of damage, both aspects make it possible to reliably prevent flames from uncontrolledly getting into the environment via the silencer, and thereby pose a danger to operating personnel.

In an advantageous further development, the flow-carrying component is a preferably multilayer knitted, crocheted, or braided fabric preferably consisting of precious metal wires, which in particular has a thickness of 50 mm±45 mm, preferably a thickness of 50 mm±35 mm, especially preferably a thickness of 50 mm±25 mm. Such a knitted, crocheted, or braided wire makes it possible to especially reliably and easily prevent flames from getting into the environment of the latter in the event of damage.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Preferred further developments of the invention may be gleaned from the subclaims and following description. Exemplary embodiments of the invention are explained in greater detail based on the drawing, without being limited hereto. Shown here on:

FIG. 1 is a cross section through a turbocharger according to prior art;

FIG. 2 is a perspective view of a silencer of a turbocharger; and

FIG. 3 is a cross section through the silencer.

### DETAILED DESCRIPTION OF THE PRESENTLY PREFERRED EMBODIMENTS

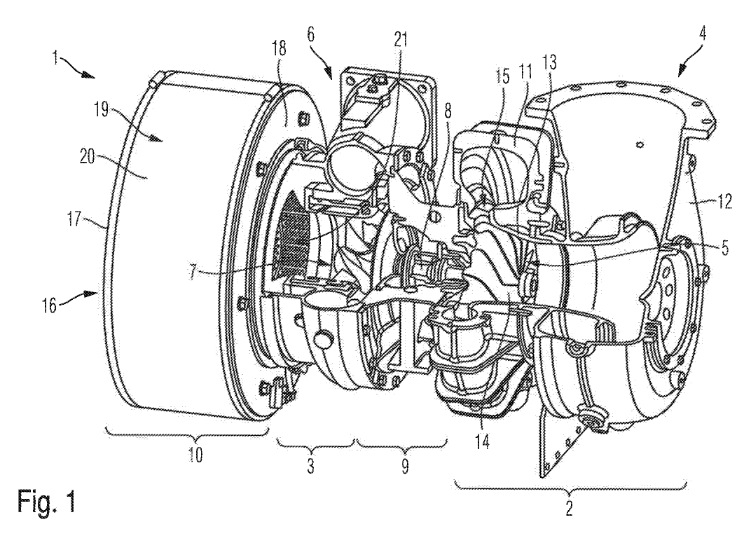

The invention relates to a compressor, in particular of a turbocharger, as well as to a silencer of such a compressor. The basic structural design of a turbocharger and silencer of the compressor of the turbocharger was already described in detail drawing reference to FIG. 1. Only those details that distinguish the silencer according to the invention from prior art will be touched upon below.

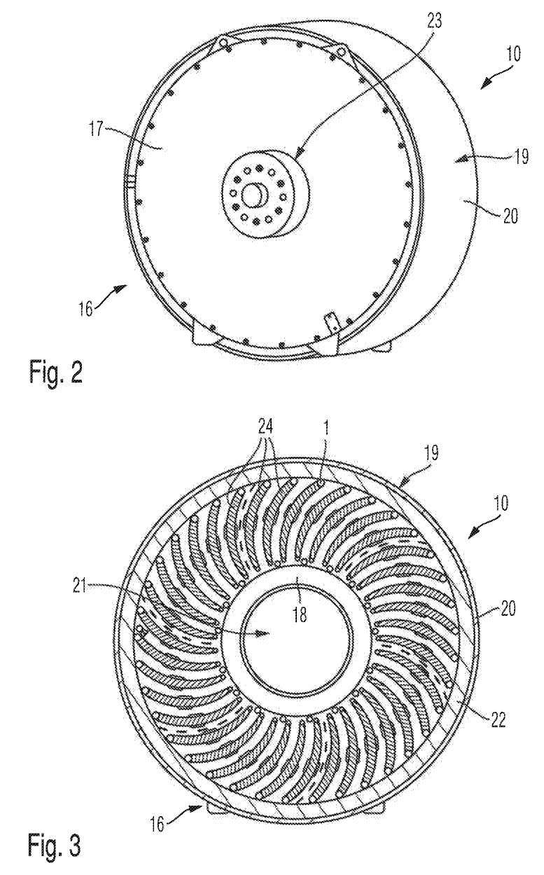

FIG. 2 shows a silencer 10 by itself. FIG. 3 shows a cross section through the latter. Visible in FIG. 1 is the front plate 17 of the in particular cylindrical housing 16 of the silencer 10, as is the particular cylindrical circumferential surface 19 extending in the circumferential direction, which outwardly or radially outwardly borders a suction area of the silencer and is defined at least in sections by a filter fleece 20. The filter fleece 20 consists in particular of a plastic, such as polyester. The air to be compressed can be aspirated, and hereby filtered, via the filter fleece 20. The aspirated air can be supplied to the compressor via the recess 20 introduced into the rear plate 18 of the housing 16 of the silencer 10. Flow guiding elements 24 are arranged inside of the housing 16. The air aspirated and filtered in the area of the filter fleece 20 can be guided in the direction of the recess 21 via the flow guiding elements 24.

In a first aspect, a metal wire component 22 is arranged in the suction area of the silencer 10 or adjacent to the suction area of the silencer 10, in particular immediately underneath the filter fleece 20, as a flame absorber.

The metal wire component 22 is preferably arranged between the circumferential surface 19, in particular the filter fleece 20, and the flow guiding elements 24 of the silencer 10.

The filter fleece 20 preferably lies directly outside on the metal wire component 22, which acts as a flame absorber.

In particular, the metal wire component 22 involves a knitted, crocheted, or braided fabric comprised of wires, preferably of several layers of a knitted, crocheted, or braided fabric comprised of wires, wherein the wires are preferably made out of precious metal.

The wire component 22, meaning the multilayer knitted or crocheted or braided fabric comprised of metal wires, preferably has a thickness of 50 mm±45 mm, preferably a thickness of 50 mm±35 mm, especially preferably a thickness of 50 mm±25 mm. In particular, the individual layers of the wire component 22 are here coarse-meshed, with a mesh size of up to 10 cm.

A metal wire component 22 acting as a flame absorber can be used to reliably prevent flames from getting into the environment via the silencer 10 in the event of damage.

The wire component 22 arranged in the suction area of the silencer 10 or adjacent to the suction area of the silencer 10 impairs neither the acoustic properties nor the flow properties of the silencer 10.

It is basically possible to arrange the wire component 22 on a side of the flow guiding element 24 in the housing 16 facing away from the filter fleece 20. However, it is preferred that the wire component 22 be arranged on a side of the flow guiding elements 24 in the housing 16 facing the filter fleece 20, i.e., positioned between the circumferential surface 19, in particular the filter fleece 20, and the flow guiding elements 24 of the silencer.

In a second aspect, an explosion-relief valve 23 with integrated flame absorber is alternatively or preferably also integrated into the front plate 18 of the housing 16, which has the recess 21. This also makes it possible to reliably prevent flames from getting into the environment via the silencer in the event of damage. The explosion-relief valve 23 already opens when exposed to a slight excess pressure, and removes air from the silencer in a defined manner. This makes it possible to counteract the formation of flames.

The silencer 10 is preferably used on a compressor of a turbocharger. However, the silencer 10 can also be used in other flow machines configured as compressors or superchargers.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A silencer of a compressor for aspirating air to be compressed, comprising:
a housing having a front plate and a rear plate;
a circumferential surface extending between the front plate and rear plate and bordering a suction area, via which the air can is aspirated;
a recess in the rear plate, via which the aspirated air can be supplied to the compressor; and
a flow-carrying metal component, configured as a wire component, is arranged in or adjacent to the suction area as a flame absorber.

2. The silencer according to claim 1, wherein the circumferential surface bordering the suction area is defined at least in sections by a filter fleece, wherein the flow-carrying metal component is arranged underneath the filter fleece.

3. The silencer according to claim 1, wherein the flow-carrying metal component is a multilayer fabric consisting of wires that is one of knitted, crocheted, and braided.

4. The silencer according to claim 1, wherein the flow-carrying metal component has a thickness of at least one of 50 mm±45 mm, 50 mm±35 mm, and 50 mm±25 mm.

5. The silencer according to claim 2, wherein the filter fleece lies directly on the flow-carrying metal component.

6. The silencer according to claim 2, wherein the filter fleece is formed by the flow-carrying metal component.

7. The silencer according to claim 1, wherein the flow-carrying metal component comprises stainless steel.

8. The silencer according to claim 1, wherein the flow-carrying metal component is arranged between the circumferential surface and flow guiding elements of the silencer.

9. The silencer according to claim 1, wherein an explosion-relief valve with an integrated flame absorber is integrated into the front plate.

10. A silencer of a compressor for aspirating air to be compressed, comprising:
a housing having a front plate and a rear plate;
a circumferential surface extending between the front plate and rear plate and bordering a suction area, via which the air can be aspirated;
a recess in the rear plate, via which the aspirated air can be supplied to the compressor; and
an explosion-relief valve with an integrated flame absorber is integrated into the front plate.

11. A compressor for compressing air, comprising:
a silencer for aspirating the air to be compressed, comprising:
a housing having a front plate and a rear plate;
a circumferential surface extending between the front plate and rear plate and bordering a suction area, via which the air can is aspirated;
a recess in the rear plate, via which the aspirated air can be supplied to the compressor; and
a flow-carrying metal component, configured as a wire component, is arranged in or adjacent to the suction area as a flame absorber.
